(19) United States
(12) Patent Application Publication
(10) Pub. No.: US 2022/0157099 A1
(43) Pub. Date: May 19, 2022

(54) DRIVE DATA-RECORDING APPARATUS, DRIVE ASSIST SYSTEM, DRIVE DATA-RECORDING METHOD, AND PROGRAM

(71) Applicant: HONDA MOTOR CO., LTD., Tokyo (JP)

(72) Inventor: Ryusuke Tamanaha, Tokyo (JP)

(21) Appl. No.: 17/525,996

(22) Filed: Nov. 15, 2021

(30) Foreign Application Priority Data
Nov. 17, 2020 (JP) 2020-190842

(51) Int. Cl. G07C 5/08; B60W 40/09

(52) U.S. Cl. CPC G07C 5/0866; B60W 2040/089; B60W 2540/229; B60W 40/09

(57) ABSTRACT

A drive data-recording apparatus includes: an outside situation information acquisition part that acquires outside situation information indicating a situation of an outside of a movable body during traveling of the movable body; a capability information acquisition part that acquires capability information indicating an outside recognition capability of a driver of the movable body; and an information-processing part that processes the outside situation information based on the capability information.

### CROSS-REFERENCE TO RELATED APPLICATION

Priority is claimed on Japanese Patent Application No. 2020-190842, filed on Nov. 17, 2020, the contents of which are incorporated herein by reference.

### BACKGROUND

### Field of the Invention

The present invention relates to a drive data-recording apparatus, a drive assist system, a drive data-recording method, and a program.

### Background

In the related art, a so-called drive recorder that is arranged on a movable body such as a vehicle and records a situation around an arrangement position in the form of voice, video, or the like has been practically realized (for example, refer to Japanese Unexamined Patent Application, First Publication No. 2020-052634). The information recorded in the drive recorder is used for reviewing a traffic accident, investigation of the cause of an accident, and the like.

### SUMMARY

However, the information recorded by the drive recorder of the related art is information indicating the surrounding situation at the time point of recording as is. Therefore, there is a possibility that by only using the information recorded in the drive recorder, it is not possible to know how a driver of the movable body recognizes the situation.

An object of an aspect of the present invention is to provide a drive data-recording apparatus, a drive assist system, a drive data-recording method, and a program capable of recording a situation around a movable body in a form in accordance with an outside recognition capability of a driver.

A first aspect of the present invention is a drive data-recording apparatus, including: an outside situation information acquisition part that acquires outside situation information indicating a situation of an outside of a movable body during traveling of the movable body; a capability information acquisition part that acquires capability information indicating an outside recognition capability of a driver of the movable body; and an information-processing part that processes the outside situation information based on the capability information.

A second aspect of the present invention is the drive data-recording apparatus according to the first aspect described above, wherein the outside situation information acquisition part may acquire image data in which the outside of the movable body is imaged as the outside situation information, the capability information acquisition part may acquire information indicating eyesight of the driver during driving of the movable body as the capability information, and the information-processing part may process the image data based on the information indicating the eyesight of the driver.

A third aspect of the present invention is the drive data-recording apparatus according to the first aspect described above, wherein the outside situation information acquisition part may acquire voice data in which a voice of the outside of the movable body is recorded as the outside situation information, the capability information acquisition part may acquire information indicating hearing of the driver during driving of the movable body as the capability information, and the information-processing part may process the voice data based on the information indicating the hearing of the driver.

A fourth aspect of the present invention is the drive data-recording apparatus according to any one of the first to third aspects described above which may further include: an information output part that determines an attribute of a device of an output destination and outputs the outside situation information after processing by the information-processing part to the device of the output destination in a case where it is determined that the attribute is a predetermined attribute.

A fifth aspect of the present invention is the drive data-recording apparatus according to any one of the first to third aspects described above which may further include: a storage part that stores the outside situation information before processing; and an information output part that commands the information-processing part to process the outside situation information before the processing in a case where it is determined that the outside situation information after processing is output.

A sixth aspect of the present invention is a drive assist system, including: the drive data-recording apparatus according to any one of the first to fifth aspects described above; and a drive data analysis device that includes: a drive data collection part that collects drive data which includes at least the capability information and the outside situation information after processing by the information-processing part from one or more drive data-recording apparatuses; a drive data analysis part that analyzes a drive risk relating to driving of the movable body based on the drive data; and an assist information supply part that generates drive assist information for assisting driving of a target person of drive assist based on an analysis result of the drive risk and supplies the generated drive support information to a drive assist device used by the target person.

A seventh aspect of the present invention is the drive assist system according to the sixth aspect described above which may further include the drive assist device including: a drive assist information acquisition part that acquires the drive assist information from the drive data analysis device; and a notification part that notifies the target person of the drive risk relating to driving of the movable body based on the drive assist information.

An eighth aspect of the present invention is the drive assist system according to the seventh aspect described above, wherein the drive data analysis part may analyze the drive risk associated with a location, and the notification part may notify the target person of an alert relating to the location.

A ninth aspect of the present invention is a drive data-recording method by way of a computer, the method including: acquiring outside situation information indicating a situation of an outside of a movable body during traveling of the movable body; acquiring capability information indicating an outside recognition capability of a driver of the movable body; and processing the outside situation information based on the capability information.

A tenth aspect of the present invention is a computer-readable non-transitory recording medium which includes a program causing a computer to: acquire outside situation information indicating a situation of an outside of a movable body during traveling of the movable body; acquire capability information indicating an outside recognition capability of a driver of the movable body; and process the outside situation information based on the capability information.

According to the first to tenth aspects described above, by acquiring outside situation information indicating a situation of an outside of a movable body during traveling of the movable body, acquiring capability information indicating an outside recognition capability of a driver of the movable body, and processing the outside situation information based on the capability information, it is possible to record the situation around the movable body in a form in accordance with the outside recognition capability of the driver.

### BRIEF DESCRIPTION OF THE DRAWINGS

FIG. 1 is a view showing a configuration example of a drive assist system according to an embodiment.

FIG. 2 is a view schematically showing the drive assist system according to the embodiment.

FIG. 3 is a view showing an example of processing of outside situation information acquired as image data in a drive data-recording apparatus according to the embodiment.

FIG. 4 is a sequence view showing an example of a process flow performed for realizing drive assist for an assist target person by the drive assist system according to the embodiment.

FIG. 5 is a view showing an example of the outside situation information according to the embodiment.

FIG. 6 is a view showing an example of capability information according to the embodiment.

FIG. 7 is a view showing an example of an analysis result of a drive risk according to the embodiment.

### DESCRIPTION OF EMBODIMENTS

Hereinafter, a drive data-recording apparatus, a drive assist system, a drive data-recording method, and a program according to an embodiment of the present invention will be described with reference to the drawings.

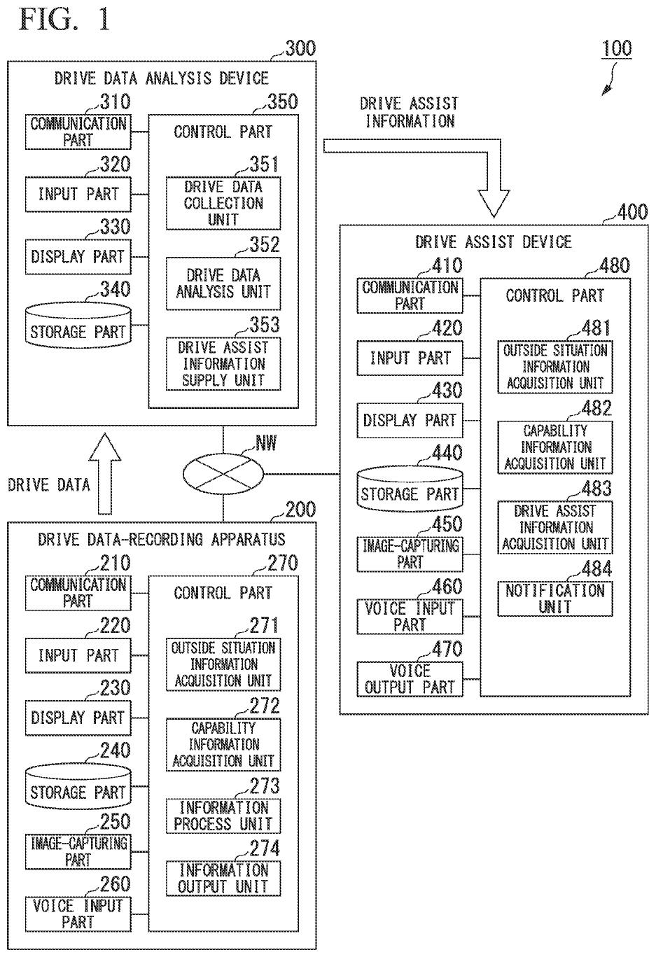

FIG. 1 is a view showing a configuration example of a drive assist system 100 according to an embodiment. The drive assist system 100 includes a drive data-recording apparatus 200, a drive data analysis device 300, and a drive assist device 400. The drive data-recording apparatus 200, the drive data analysis device 300, and the drive assist device 400 are connected so as to be capable of communicating with one another via a network NW. For example, the network NW is a WAN (Wide Area Network) that includes the Internet, a cellular network, and the like.

The drive data-recording apparatus 200 is, for example, an apparatus that functions as a so-called drive recorder that is arranged on a movable body such as a vehicle and records a situation around an arrangement position in the form of voice, video, or the like. Hereinafter, information indicating a situation around the movable body on which the drive data-recording apparatus 200 is arranged is referred to as “outside situation information”.

In addition to such a record function of the outside situation information, the drive data-recording apparatus 200 of the present embodiment has a function of acquiring “capability information” indicating an outside recognition capability of a driver of the movable body on which the apparatus is provided. The outside recognition capability is a capability of recognizing the situation outside the movable body during driving of the movable body by the driver of the movable body. The drive data-recording apparatus 200 of the present embodiment has a function of supplying data such as the outside situation information and the capability information acquired in this way as data used for analyzing a drive risk described later to the drive data analysis device 300. Hereinafter, the data for analysis that is supplied to the drive data analysis device 300 by the drive data-recording apparatus 200 is referred to as “drive data”.

The drive data analysis device 300 is a device that analyzes the drive data supplied from the drive data-recording apparatus 200. More specifically, the drive data analysis device 300 analyzes a risk (hereinafter, referred to as a “drive risk”) relating to driving of the movable body on the basis of drive data collected from one or more drive data-recording apparatuses 200 and generates drive assist information on the basis of the analysis result. The drive assist information is information that assists driving of a movable body by a target person. For example, the drive data analysis device 300 generates information indicating a drive risk that applies to a target person as the drive assist information on the basis of the analysis result of the drive risk and the outside recognition capability of the target person. The drive data analysis device 300 supplies the generated drive assist information to the drive assist device 400 mounted on the movable body driven by the target person.

The drive assist device 400 is, for example, a device that is arranged on a movable body driven by a target person of drive assist and assists driving of the movable body by the target person. More specifically, the drive assist device 400 acquires the drive assist information from the drive data analysis device 300 and supports driving of the target person by performing an operation (hereinafter, referred to as a “drive assist operation”) based on the acquired drive assist information. For example, as an example of the drive assist operation, the drive assist device 400 may perform an operation of notifying the driver of contents indicated by the drive assist information or may perform an operation of aiding a drive operation on the basis of the contents indicated by the drive assist information.

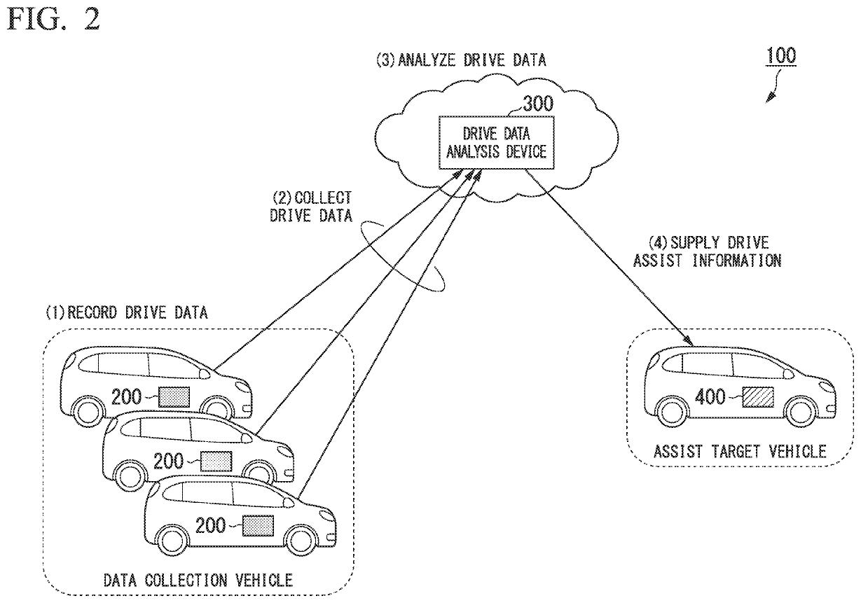

Hereinafter, configurations of the drive data-recording apparatus 200, the drive data analysis device 300, and the drive assist device 400 are described in more detail. In the following description, a case is assumed in which the drive data-recording apparatus 200 and the drive assist device 400 are mounted on a vehicle as shown in FIG. 2 for ease of understanding. In the following description, a vehicle on which the drive data-recording apparatus 200 is provided may be referred to as a “data collection vehicle”, a vehicle on which the drive assist device 400 is provided may be referred to as an “assist target vehicle”, and thereby, the vehicles may be distinguished from each other. In the following description, a driver of the data collection vehicle may be referred to as an “analysis target person”, a driver of the assist target vehicle may be referred to as an “assist target person”, and thereby, the persons may be distinguished from each other.

The drive data-recording apparatus 200 includes a communication part 210, an input part 220, a display part 230, a storage part 240, an image-capturing part 250, a voice input part 260, and a control part 270. The control part 270 among these components is, for example, realized by a hardware processor such as a CPU (Central Processing Unit) executing a program (software). Some or all of these components may be realized by hardware (a circuit part including circuitry) such as a LSI (Large-Scale Integration), an ASIC (Application-Specific Integrated Circuit), a FPGA (Field-Programmable Gate Array), or a GPU (Graphics-Processing Unit) or may be realized by software and hardware in cooperation. The program may be stored in advance in a storage device (a storage device including a non-transitory storage medium) such as a HDD (Hard Disk Drive) or a flash memory or may be stored in a removable storage medium (non-transitory storage medium) such as a DVD or a CD-ROM and may be installed by mounting the storage medium on a drive device.

The communication part 210 is a communication interface that connects the drive data-recording apparatus 200 to the network NW. For example, the communication part 210 is constituted using a wireless communication interface connected to a cellular network. The communication part 210 is connected to the drive data analysis device 300 so as to be capable of communicating with the drive data analysis device 300 via the network NW.

The input part 220 is constituted using an input device such as a button, a switch, a keyboard, a mouse, a touch panel, or the like. The input part 220 receives an operation input with respect to the drive data-recording apparatus 200. The input part 220 outputs input information indicating the contents of the received operation input to the control part 270.

The display part 230 is constituted using a display device such as a liquid crystal display, an organic EL (Electro-luminescence) display, a touch panel, or the like. The display part 230 is capable of displaying arbitrary information on the basis of a command of the control part 270. For example, the drive data recorded in the drive data-recording apparatus 200 may be displayed on the display part 230.

The storage part 240 is constituted using a storage device such as a HDD or a flash memory. A variety of information relating to an operation of the drive data-recording apparatus 200 in addition to data of a program executed by the drive data-recording apparatus 200, image data or video data acquired by the image-capturing part 250, voice data acquired by the voice input part 260, and the like are stored in the storage part 240.

The image-capturing part 250 is constituted using an image-capturing device such as a camera. The image-capturing part 250 is provided at a position and an attitude capable of imaging the outside situation of the vehicle with respect to the data collection vehicle on which the drive data-recording apparatus 200 is provided. The image-capturing part 250 generates image data of a subject by performing an image capture operation in response to a command of the control part 270. The image-capturing part 250 may be constituted so as to be capable of adjusting the imaging range by a command of the control part 270. The image-capturing part 250 outputs the generated image data to the control part 270.

The voice input part 260 is constituted using a voice input device such as a microphone. The voice input part 260 is provided at a position where an outside voice of the vehicle can be recorded on the data collection vehicle on which the drive data-recording apparatus 200 is provided. The voice input part 260 performs a recording operation in response to a command of the control part 270 and thereby generates voice data in which the outside voice of the data collection vehicle is recorded. The voice input part 260 outputs the generated voice data to the control part 270.

The control part 270 has a function of inputting and outputting information with the communication part 210, the input part 220, the display part 230, the storage part 240, the image-capturing part 250, and the voice input part 260 and controlling the operation of the drive data-recording apparatus 200. Here, the control function of the control part 270 includes a function of acquiring outside situation information relating to a data collection vehicle on which the drive data-recording apparatus 200 is provided, a function of acquiring capability information of a driver who drives the vehicle, a function of processing the acquired outside situation information, and an output function of a variety of information including the outside situation information. The control part 270 includes an outside situation information acquisition unit 271, a capability information acquisition unit 272, an information process unit 273, and an information output unit 274 as functional units realizing these functions.

The outside situation information acquisition unit 271 causes the image-capturing part 250 and the voice input part 260 to perform an imaging operation and a recording operation, respectively, at a predetermined time and thereby acquires the outside situation information indicating the outside situation of the vehicle during traveling of the data collection vehicle. The outside situation information acquisition unit 271 records the acquired outside situation information in the storage part 240.

The capability information acquisition unit 272 acquires capability information indicating the outside recognition capability during driving of the vehicle with respect to a driver of the data collection vehicle. For example, the capability information acquisition unit 272 acquires information indicating eyesight or hearing of the driver of the data collection vehicle as the capability information. The information indicating the eyesight or the hearing of the driver of the data collection vehicle may be stored in the storage part 240 in advance or may be received from another device via the communication part 210. The capability information acquisition unit 272 may acquire information indicating the eyesight or the hearing in accordance with a state of the driver during driving of the vehicle as the capability information in a case where the biological information of the driver who drives the data collection vehicle can be acquired.

Examples of the biological information include heart rate, respiratory rate, blood pressure, body temperature, awareness degree, and the like. Some or all of these types of biological information may be generated by the capability information acquisition unit 272 or may be acquired from an information terminal such as a so-called smart watch having an acquisition function of the biological information. Examples of a measurement method of the biological information include a direct measurement method using a dedicated medical measurement device, a measurement method by image processing, a measurement method by voice processing, and the like. In a case where the capability information acquisition unit 272 generates such biological information, the drive data-recording apparatus 200 may include a voice input part or an image-capturing part for acquiring the biological information in addition to the voice input part 260 and the image-capturing part 250 for acquiring the outside situation information.

For example, the capability information acquisition unit 272 may acquire an outside recognition capability obtained by correcting the outside recognition capability at an ordinary time of the driver of the data collection vehicle in accordance with a value of the biological information as the capability information. For example, assuming that a driver's eyesight is 1.0 at a normal level of awareness, in a case where it is detected that the awareness degree during driving is decreased to about half of the normal level, for example, the capability information acquisition unit 272 may determine that the eyesight of the driver at that time is 0.5. The capability information acquisition unit 272 records the capability information acquired in this way in the storage part 240.

The information process unit 273 processes the outside situation information acquired with respect to the data collection vehicle on the basis of the capability information acquired with respect to the driver of the vehicle at the time of acquiring the outside situation information. The information process unit 273 records the outside situation information after processing in the storage part 240. The information process unit 273 may process the acquired outside situation information itself or may process a copy of the acquired outside situation information.

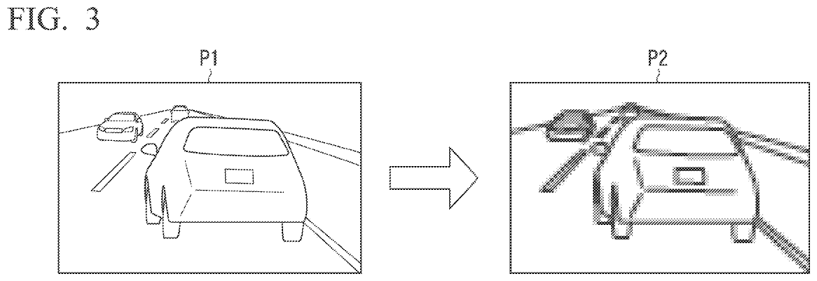

FIG. 3 is a view showing an example of processing of outside situation information acquired as image data. An image P1 shows an example of an image indicated by image data before processing, and an image P2 shows an example of an image indicated by image data after processing. Here, the image P2 after processing is an image generated by decreasing the resolution of the image P1 before processing. For example, the image P2 may be generated by a so-called airbrushing process that determines each pixel value of the image P2 on the basis of a plurality of pixel values of the corresponding image P1.

In this case, for example, the information process unit 273 can generate the image P2 by determining the resolution of the image after processing on the basis of the outside recognition capability of the driver of the data collection vehicle and performing the airbrushing process with respect to the image P1 such that the resolution becomes the determined resolution. For example, in a case where the eyesight is measured using a Landolt ring, the information process unit 273 can determine the resolution of the image after processing on the basis of the information indicating the eyesight of the driver by using the relationship of the following Expression (1).

[Expression 1]

Res=Itr×Ld/(Lx×Od) (1)

In Expression (1), Res represents a resolution [dpi] of an image after processing. Ld represents a reference distance from the Landolt ring to the center of the observing point. Specifically, Ld is 5 [m].

Itr represents 25.4 [mm] which is an actual size of 1 inch. Ps represents the eyesight of the driver. Lx represents a length [mm] of a gap of the Landolt ring depending on the eyesight. Od represents a distance from the observing point of the driver to an object captured in the image. The Od may be a distance estimated on the basis of image data or may be a distance measured by a sensor such as a LiDAR (Light Detection and Ranging). According to Expression (1), in accordance with the eyesight of the driver during driving of the data collection vehicle, the definition of a scene that the driver would have visually perceived during driving can be acquired as the resolution (hereinafter, referred to as a “capability equivalent resolution”) of the image. The information process unit 273 generates an image P2 in which the resolution of the image P1 before processing is decreased to the capability equivalent resolution and can thereby acquire image data indicating the outside situation that the driver of the data collection vehicle would have perceived during driving of the vehicle.

As another example of a method of processing outside situation information, it is conceivable that the outside voice data obtained as the outside situation information be processed on the basis of information indicating the hearing of the driver when driving the data collection vehicle. In this case, for example, the information process unit 273 can acquire voice data indicating the outside situation that the driver of the data collection vehicle would have perceived by hearing by acquiring an audiogram representing the hearing of the driver in hertz and decibel as the capability information and converting the audiogram of the voice data in accordance with the hearing of the driver.

In this way, the information process unit 273 processes the outside situation information on the basis of the capability information of the driver and thereby generates information indicating the outside situation that the driver of the vehicle would have perceived during traveling of the data collection vehicle. In this sense, the outside situation information after processing may be referred to as perception information in the following description. The generated perception information is associated with the outside situation information and capability information of the generation origin and is recorded in the storage part 240 by the information process unit 273.

The information output unit 274 has a function of outputting a variety of information held in the drive data-recording apparatus 200 to the outside as needed. Here, the form of information output to the outside includes displaying of information by a display device, outputting of voice by a voice output device, recording of information on a recording medium, and the like in addition to data transmission performed through the communication part 210. Specifically, the information output unit 274 is constituted such that, in a case where a device (hereinafter, referred to as a “target device”) designated as an output destination satisfies a predetermined condition, an output of information to the target device is performed.

For example, the information output unit 274 may be constituted such that the information output unit 274 determines whether or not the target device has a predetermined attribute and outputs the information to the target device in a case where it is determined that the target device has the predetermined attribute. In this case, the attribute to be determined with respect to the target device may be an arbitrary attribute as long as it is possible to determine whether or not the target device is appropriate as a supply destination of the information.

For example, the attribute of the target device may be identification information of the target device, may be information indicating an owner of the target device, may be information indicating the model, the type, or the like of the target device, or may be an attribute relating to the function included in the target device. In this way, the information output unit 274 outputs the information to the target device in a case where the target device is a device having a predetermined attribute, and thereby, it is possible to prevent the perception information, the capability information, and the like, which can be personal information, from being distributed to a large number of unspecified devices.

The information output unit 274 may be constituted such that the information output unit 274 outputs information to the target device in a case where an operation that permits outputting of information with respect to the target device is input. The information output unit 274 may be constituted such that the information to be output and the form of the information output are changed depending on the attribute of the target device. For example, the information output unit 274 may be constituted such that, with respect to outputting of information on the basis of the outside situation information, the information output unit 274 outputs perception information which is the outside situation information after processing to a particular target device and outputs the outside situation information before processing to a target device other than the particular target device. For example, the information output unit 274 may be constituted to command the information process unit 273 to generate perception information (process the outside situation information) when outputting of the perception information is required.

On the other hand, the information output unit 274 transmits, to the drive data analysis device 300, drive data that includes at least the perception information acquired with respect to the driver of the vehicle and the capability information associated with the perception information. The perception information and the capability information that are transmitted to the drive data analysis device 300 are used for the analysis of a risk relating to driving, and the drive assist information based on the analysis result is supplied to the drive assist device 400 used by the driver of the assist target vehicle.

Subsequently, the configuration of the drive data analysis device 300 is described. The drive data analysis device 300 includes a communication part 310, an input part 320, a display part 330, a storage part 340, and a control part 350. The control part 350 among these components is, for example, realized by a hardware processor such as a CPU executing a program (software). Some or all of these components may be realized by hardware (a circuit part including circuitry) such as a LSI, an ASIC, a FPGA, or a GPU or may be realized by software and hardware in cooperation. The program may be stored in advance in a storage device (a storage device including a non-transitory storage medium) such as a HDD or a flash memory or may be stored in a removable storage medium (non-transitory storage medium) such as a DVD or a CD-ROM and may be installed by mounting the storage medium on a drive device.

The communication part 310 is a communication interface that connects the drive data analysis device 300 to the network NW. For example, the communication part 310 is constituted using a wired or wireless LAN (Local Area Network) interface that can be connected to the Internet. The communication part 310 is connected to the drive data-recording apparatus 200 and the drive assist device 400 so as to be capable of communicating with the drive data-recording apparatus 200 and the drive assist device 400 via the network NW.

The input part 320 is constituted using an input device such as a button, a switch, a keyboard, a mouse, a touch panel, or the like. The input part 320 receives an operation input with respect to the drive data analysis device 300. The input part 320 outputs input information indicating contents of the received operation input to the control part 350.

The display part 330 is constituted using a display device such as a liquid crystal display, an organic EL display, a touch panel, or the like. The display part 330 is capable of displaying arbitrary information on the basis of a command of the control part 350.

The storage part 340 is constituted using a storage device such as a HDD or a flash memory. A variety of information relating to an operation of the drive data analysis device 300 in addition to data of a program executed by the drive data analysis device 300, drive data acquired from the drive data-recording apparatus 200, information indicating an analysis result of those data, drive assist information generated on the basis of the analysis result, and the like are stored in the storage part 340.

The control part 350 has a function of inputting and outputting information with the communication part 310, the input part 320, the display part 330, and the storage part 340 and controlling the operation of the drive data analysis device 300. Here, the control function of the control part 350 includes a function of collecting the drive data of the analysis target person from the drive data-recording apparatus 200 of each data collection vehicle, a function of analyzing the collected drive data, and a function of generating the drive assist information on the basis of the analysis result of the drive data. The control part 350 includes a drive data collection unit 351, a drive data analysis unit 352, and a drive assist information supply unit 353 as functional units realizing these functions.

The drive data collection unit 351 has a function of collecting drive data from one or more drive data-recording apparatuses 200. The drive data collection unit 351 records drive data collected from each drive data-recording apparatus 200 in the storage part 340.

The drive data analysis unit 352 has a function of analyzing a drive risk relating to driving of the vehicle on the basis of the drive data collected from each drive data-recording apparatus 200. An analysis method of the drive data will be described later. The drive data analysis unit 352 records the analysis result of the drive risk in the storage part 340.

The drive assist information supply unit 353 has a function of providing drive assist information for assisting driving of the vehicle to a driver of the assist target vehicle. Specifically, the drive assist information supply unit 353 generates drive assist information on the basis of the analysis result of the drive risk and transmits the generated drive assist information to the drive assist device 400. The drive assist information supply unit 353 may be constituted to periodically generate and transmit the drive assist information or may be constituted to generate and transmit the drive assist information when receiving a request for the drive assist information from the drive assist device 400.

Subsequently, the configuration of the drive assist device 400 is described. The drive assist device 400 includes a communication part 410, an input part 420, a display part 430, a storage part 440, an image-capturing part 450, a voice input part 460, a voice output part 470, and a control part 480. The control part 480 among these components is, for example, realized by a hardware processor such as a CPU executing a program (software). Some or all of these components may be realized by hardware (a circuit part including circuitry) such as a LSI, an ASIC, a FPGA, or a GPU or may be realized by software and hardware in cooperation. The program may be stored in advance in a storage device (a storage device including a non-transitory storage medium) such as a HDD or a flash memory or may be stored in a removable storage medium (non-transitory storage medium) such as a DVD or a CD-ROM and may be installed by mounting the storage medium on a drive device.

The communication part 410 is a communication interface that connects the drive assist device 400 to the network NW. For example, the communication part 410 is constituted using a wireless communication interface that is connected to a cellular network. The communication part 410 is connected to the drive data analysis device 300 so as to be capable of communicating with the drive data analysis device 300 via the network NW.

The input part 420 is constituted using an input device such as a button, a switch, a keyboard, a mouse, a touch panel, or the like. The input part 420 receives an operation input with respect to the drive assist device 400. The input part 420 outputs input information indicating the contents of the received operation input to the control part 480.

The display part 430 is constituted using a display device such as a liquid crystal display, an organic EL display, a touch panel, or the like. The display part 430 is capable of displaying arbitrary information on the basis of a command of the control part 480. For example, the drive assist information supplied from the drive data analysis device 300 may be displayed on the display part 430. For example, the display part 430 may be used as one of the means of reporting information by a notification part described later.

The storage part 440 is constituted using a storage device such as a HDD or a flash memory. A variety of information relating to an operation of the drive assist device 400 in addition to data of a program executed by the drive assist device 400, image data or video data acquired by the image-capturing part 450, voice data acquired by the voice input part 460, the drive assist information acquired from the drive data analysis device 300, and the like are stored in the storage part 440.

The image-capturing part 450 is constituted using an image-capturing device such as a camera. The image-capturing part 450 is provided at a position and an attitude capable of imaging the outside situation of the vehicle with respect to the assist target vehicle on which the drive assist device 400 is provided. The image-capturing part 450 generates image data of a subject by performing an image capture operation in response to a command of the control part 480. The image-capturing part 450 may be constituted so as to be capable of adjusting the imaging range by a command of the control part 480. The image-capturing part 450 outputs the generated image data to the control part 480.

The voice input part 460 is constituted using a voice input device such as a microphone. The voice input part 460 is provided at a position where an outside voice of the vehicle can be recorded on the assist target vehicle on which the drive assist device 400 is provided. The voice input part 460 performs a recording operation in response to a command of the control part 480 and thereby generates voice data in which the outside voice of the assist target vehicle is recorded. The voice input part 460 outputs the generated voice data to the control part 480.

The voice output part 470 is constituted using a voice output device such as a speaker. The voice output part 470 converts a telegraph signal that is output from the control part 480 into voice and outputs the converted voice. For example, the voice output part 470 is used as one of the means of reporting information by the notification part described later.

The control part 480 has a function of inputting and outputting information with the communication part 410, the input part 420, the display part 430, the storage part 440, the image-capturing part 450, the voice input part 460, and the voice output part 470 and controlling the operation of the drive assist device 400. Here, the control function of the control part 480 includes a function of acquiring outside situation information relating to an assist target vehicle on which the drive assist device 400 is provided, a function of acquiring drive assist information from the drive data analysis device 300, and a function for causing each function unit to perform a notification operation of a predetermined event. The control part 480 includes an outside situation information acquisition unit 481, a capability information acquisition unit 482, a drive assist information acquisition unit 483, and a notification unit 484 as functional units realizing these functions.

The outside situation information acquisition unit 481 causes the image-capturing part 450 and the voice input part 460 to perform an imaging operation and a recording operation, respectively, at a predetermined time and thereby acquires data indicating the outside situation of the vehicle during traveling of the assist target vehicle as the outside situation information. The outside situation information acquisition unit 481 records the acquired outside situation information in the storage part 440.

The capability information acquisition unit 482 acquires capability information indicating outside recognition capability, which is a capability of recognizing the situation outside the vehicle during driving of the vehicle by the driver of the assist target vehicle. For example, the capability information acquisition unit 482 acquires information indicating eyesight or hearing of the driver of the assist target vehicle as the capability information. The information indicating the eyesight or the hearing of the driver of the assist target vehicle may be stored in the storage part 440 in advance or may be received from another device via the communication part 410. The capability information acquisition unit 482 may acquire information indicating the eyesight or the hearing in accordance with a state of the driver during driving of the vehicle as the capability information in a case where the biological information of the driver who drives the assist target vehicle can be acquired.

The drive assist information acquisition unit 483 has a function of acquiring drive assist information from the drive data analysis device 300. The drive assist information acquisition unit 483 may be constituted to periodically acquire the drive assist information from the drive data analysis device 300 or may be constituted to acquire the drive assist information from the drive data analysis device 300 at a particular time. For example, the drive assist information acquisition unit 483 may acquire drive assist information from the drive data analysis device 300 in a case where a command of performing the drive assist with respect to the driver of the assist target vehicle is input, or may acquire the drive assist information from the drive data analysis device 300 in a case where a situation in which the drive assist should be performed is confirmed from the outside situation information. The drive assist information acquisition unit 483 outputs the drive assist information acquired from the drive data analysis device 300 to the notification unit 484. The drive assist information acquisition unit 483 may record the acquired drive assist information in the storage part 440.

The notification unit 484 notifies the driver of the assist target vehicle of the contents of the drive assist information by outputting the drive assist information acquired from the drive data analysis device 300 in a predetermined form.

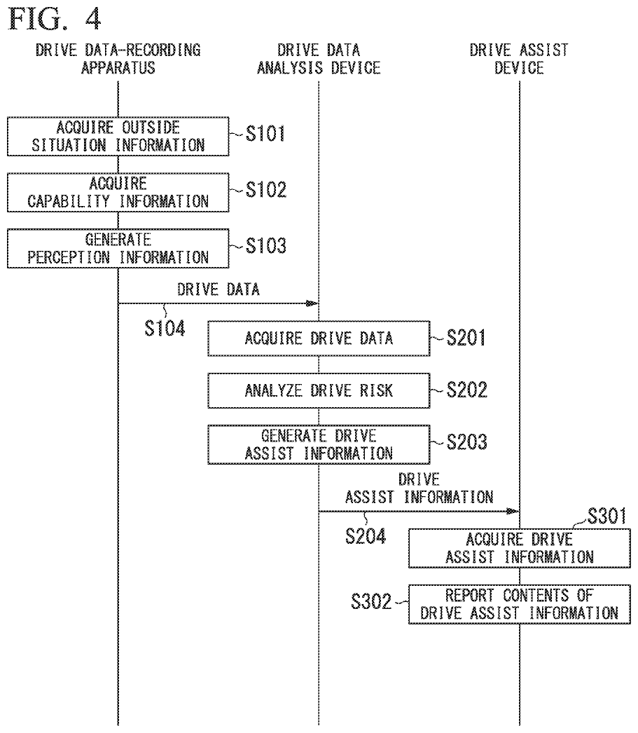

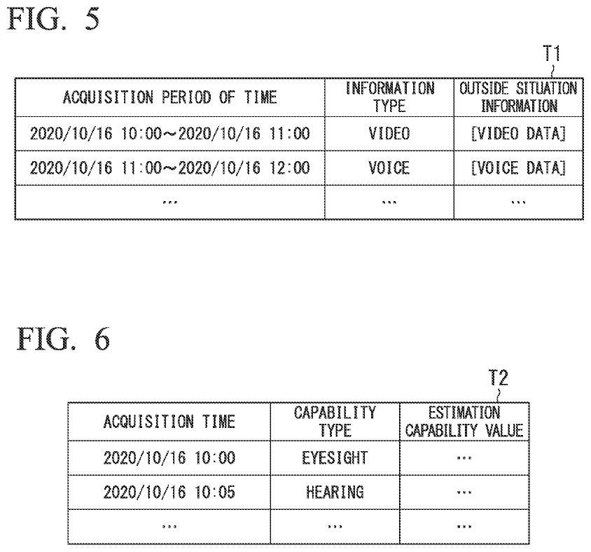

FIG. 4 is a sequence view showing an example of a process flow performed for realizing drive assist for an assist target person by the drive assist system 100 of the present embodiment. First, in the drive data-recording apparatus 200, the outside situation information acquisition unit 271 operates the image-capturing part 250 or the voice input part 260 to acquire outside situation information (Step S101). The outside situation information acquisition unit 271 records the acquired outside situation information in the storage part 240. FIG. 5 is a view showing an example of the outside situation information in the present embodiment. For example, the outside situation information is recorded in the storage part 240 in the form of an outside situation information table T1 as shown in FIG. 5. The outside situation information table T1 has one or more records having each value of an acquisition period of time, an information type, and outside situation information. Here, the acquisition period of time represents a timing when the corresponding outside situation information is acquired, and the information type represents a type of the corresponding outside situation information. The outside situation information represents data of video, voice, or the like acquired as the outside situation information. A value “[video data]” of the outside situation information in FIG. 5 represents that the value is video data acquired as the outside situation information, and a value “[voice data]” represents that the value is voice data acquired as the outside situation information.

Subsequently, the capability information acquisition unit 272 acquires capability information of a driver of a data collection vehicle at the time when the outside situation information is acquired (Step S102). The capability information acquisition unit 272 records the acquired capability information in the storage part 240. FIG. 6 is a view showing an example of the capability information in the present embodiment. For example, the capability information is recorded in the storage part 240 in the form of a capability information table T2 as shown in FIG. 6. The capability information table T2 shown in FIG. 6 is a table in which a case where the capability information acquisition unit 272 estimates a capability value in accordance with a state of the driver is assumed and has one or more records having each value of an acquisition time, a capability type, and an estimation capability value. The acquisition time represents a time when the estimation capability value is acquired, and the capability type represents a type (for example, the eyesight or the hearing) of the capability indicated by the estimation capability value. The estimation capability value represents a capability value estimated with respect to the corresponding capability type.

Subsequently, the information process unit 273 processes the outside situation information acquired in Step S101 on the basis of the capability information of the driver acquired in Step S102 and thereby generates perception information of the driver (Step S103). The generated perception information is associated with the outside situation information and the capability information that are used for generating the information and is recorded in the storage part 240 by the information process unit 273.

Subsequently, the information output unit 274 transmits, to the drive data analysis device 300, drive data including at least the perception information generated in Step S103 and the capability information corresponding to the perception information (Step S104). Here, as data required for explaining some specific examples described later with respect to the analysis of a drive risk, the drive data includes the outside situation information before processing, and information of the gender and the age of the driver, position information of the vehicle, the weather, a time zone, and the like. The capability information includes a value indicating the outside recognition capability at an ordinary time of the driver in addition to a value indicating the outside recognition capability of the driver at the time when the outside situation information is acquired. Subsequently, in the drive data analysis device 300, the drive data collection unit 351 acquires drive data from one or more drive data-recording apparatuses 200 (Step S201). The drive data collection unit 351 records the acquired drive data in the storage part 340. Subsequently, the drive data analysis unit 352 analyzes a drive risk on the basis of the drive data acquired from each drive data-recording apparatus 200 (Step S202). The drive data analysis unit 352 records the analysis result of the drive risk in the storage part 340.

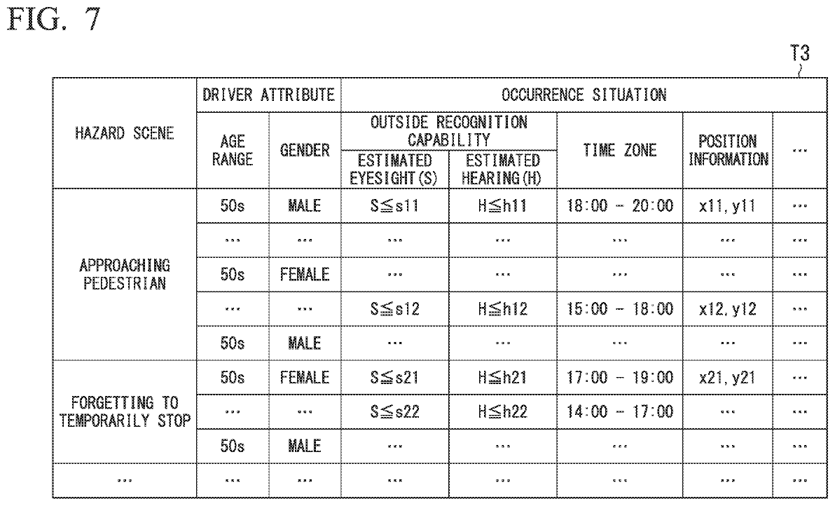

FIG. 7 is a view showing an example of an analysis result of a drive risk in the present embodiment. For example, the analysis result of the drive risk is recorded in the storage part 340 as an analysis result table T3 as shown in FIG. 7. For example, the analysis result table T3 has one or more records having each value of a hazard scene, a driver attribute and an occurrence situation. Here, the hazard scene represents a hazardous scene during driving that a driver having a corresponding driver attribute is considered likely to encounter in a corresponding occurrence situation. The driver attribute represents an attribute of a driver who is considered likely to encounter a corresponding hazard scene in a corresponding occurrence situation. The occurrence situation represents a situation where a driver having a corresponding driver attribute is likely to encounter a corresponding hazard scene.

For example, in the analysis result table T3 of the example of FIG. 7, examples of the hazard scene include “approaching a pedestrian”, “forgetting to temporarily stop” and the like. For example, the analysis result table T3 of the example of FIG. 7 represents that it is analyzed that, with respect to a 50s male driver, the “approaching a pedestrian” is likely to occur in a case where at least the following situations occur in combination.

(1) An estimated eyesight S is equal to or less than a value of s11.

(2) An estimated hearing H is equal to or less than a value of h11.

(3) A time is included in a time zone from 18:00 to 20:00.

(4) A position is within a range of a predetermined distance from a point (x11, y11).

In a case of performing such an analysis, for example, the drive data analysis unit 352 recognizes a pedestrian who is present outside the data collection vehicle with respect to the outside situation information collected as the drive data and estimates a distance between the vehicle and the pedestrian. The drive data analysis unit 352 estimates a distance to a pedestrian with respect to all of the data collection vehicles according to the collected drive data and recognizes that a situation in which the distance is equal to or less than a predetermined threshold value is the hazard scene “approaching a pedestrian”. The drive data analysis unit 352 specifies a situation where the driver is most likely to encounter a hazard scene in each combination of the driver attributes by taking statistics of situations (for example, the outside recognition capability of the driver, the time zone, the position information, and the like) where a hazard scene is recognized for each combination of the driver attributes. The drive data analysis unit 352 associates the situation specified in this way with the corresponding driver attribute and the recognized hazard scene and can thereby generate the analysis result table T3. Such an analysis method of the drive data is an example, and the analysis method of the drive data is not limited to the example described above. The type and the method of the analysis of the drive data may be arbitrary as long as at least some correlation between a risk (for example, a hazard scene in the example of FIG. 7) relating to driving and the outside recognition capability of the driver is found.

Subsequently, the drive assist information supply unit 353 generates drive assist information with respect to an assist target person on the basis of the analysis result of the drive risk performed in this way (Step S203). The drive assist information supply unit 353 records the generated drive assist information in the storage part 340 and supplies the drive assist information to the drive assist device 400 as needed (Step S204).

For example, the analysis of the drive data may be performed using a method of machine learning. In this case, for example, the drive data analysis unit 352 performs learning using data in which the drive data collected with respect to the data collection vehicle is associated with the drive risk as teacher data and thereby generates a learned model that estimates a drive risk using the drive data as an input. In this case, the drive assist information supply unit 353 can estimate the drive risk relating to the driver of the assist target vehicle by inputting the drive data acquired with respect to the assist target vehicle into the learned model. The drive assist information supply unit 353 may supply the drive assist information acquired by such a method of machine learning to the drive assist device 400.

Subsequently, in the drive assist device 400, the drive assist information acquisition unit 483 acquires the drive assist information from the drive data analysis device 300 (Step S301). The drive assist information acquisition unit 483 may be constituted to receive the drive assist information transmitted by the drive data analysis device 300 at an arbitrary time, or may be constituted to require the drive data analysis device 300 to supply the drive assist information at an arbitrary time.

For example, the drive assist information acquisition unit 483 may be constituted to request the supply of the drive assist information in a case where it is detected that the vehicle has started traveling by cooperating with a control system of a vehicle (that is, an assist target vehicle) on which the drive assist device 400 is provided or the like. For example, the drive assist information acquisition unit 483 may be constituted to request the supply of the drive assist information in a case where it is recognized that the driver of the assist target vehicle is in a state (hereinafter, referred to as an “assist required state”) that requires drive assist. For example, whether or not a driver is in the assist required state may be determined on the basis of the outside situation of the assist target vehicle which can be recognized on the basis of the outside situation information, or may be determined on the basis of the state of the assist target person which can be recognized on the basis of the capability information.

Subsequently, the notification unit 484 outputs the drive assist information acquired from the drive data analysis device 300 in a predetermined form and thereby notifies the driver of the assist target vehicle of the contents of the drive assist information (Step S302). For example, the notification unit 484 may notify the driver of the contents of the drive assist information by way of voice by generating voice data indicating the contents of the drive assist information and outputting the generated voice data to the voice output part 470. For example, the notification unit 484 may notify the driver of the contents of the drive assist information by way of video by generating a video signal indicating the contents of the drive assist information and outputting the generated video signal to the display part 430.

For example, in a case where the analysis result table T3 of the example of FIG. 7 can be obtained by the analysis of the drive data, the drive assist information acquisition unit 483 may notify the drive data analysis device 300 of the driver attribute of the assist target person when requesting the supply of drive assist information, and the drive data analysis device 300 may supply an analysis result that corresponds to the driver attribute supplied from the drive assist device 400 as drive assist information to the drive assist device 400. In this case, for example, the notification unit 484 can specify a hazard scene that should be reported to the assist target person by comparing the occurrence situation included in the drive assist information acquired from the drive data analysis device 300 with the present situation. For example, as in the analysis result table T3 of the example of FIG. 7, the drive data analysis unit 352 may be constituted to analyze a drive risk that is associated with a location on the basis of the position information of the data collection vehicle that can be included in the drive data. Further, in this case, the notification unit 484 may be constituted to notify the assist target person of an alert relating to the location.

For example, the drive assist information acquisition unit 483 may supply the information (for example, in the example of FIG. 7, the driver attribute of the assist target person, the outside recognition capability of the assist target person, the position information of the assist target vehicle, and the like) required for specifying a hazard scene to be reported to the assist target person to the drive data analysis device 300 when requesting the supply of the drive assist information, and the drive data analysis device 300 may specify the hazard scene on the basis of the information supplied from the drive assist device 400 and may supply the specified hazard scene as the drive assist information to the drive assist device 400.

The drive assist device 400 may be constituted such that in a case where it is possible to acquire route information of a route guidance from a navigation device or the like, the drive assist device 400 performs notification of the route information when requesting the drive assist information from the drive data analysis device 300. In this case, the drive data analysis device 300 may be constituted to determine a travel route (hereinafter, referred to as a “recommendation route”) that can further reduce the drive risk on the basis of the route information of the assist target vehicle and the analysis result of the drive risk and transmit the drive assist information including the determined recommendation route to the drive assist device 400 of the assist target vehicle.

The drive data-recording apparatus 200 of the embodiment having a configuration as described above includes the information process unit 273 that processes the outside situation information on the basis of the outside recognition capability of the driver of the vehicle on which the apparatus is provided. By including such a configuration, the drive data-recording apparatus 200 of the embodiment can realize a new recording function of recording the outside situation in a form in accordance with the outside recognition capability of the driver in place of or in addition to a function as a so-called conventional drive recorder in which the situation in the vicinity (outside) of the movable body is recorded by way of an image or voice as is. The outside situation information (that is, the perception information) recorded in such a new form can be a clue to know the difference between the actual outside situation and the outside situation perceived by the driver and therefore can be used as evidence when performing inspection at the time of the occurrence of an accident and can also be used as a teaching material for sharing near-miss information during driving.

The drive assist system 100 of the embodiment having a configuration as described above includes one or more drive data-recording apparatuses 200 that supply drive data including the outside recognition capability of the driver to the drive data analysis device 300, the drive data analysis device 300 that analyzes the drive data collected from the drive data-recording apparatus 200, and the drive assist device 400 that assists driving of the assist target person on the basis of the analysis result of the drive data. By including such a configuration, the drive assist system 100 of the embodiment can perform an appropriate assist to the driver in accordance with the outside recognition capability of the driver.

The drive data-recording apparatus 200 and the drive assist device 400 may be integrally constituted as an apparatus including the functions of both the drive data-recording apparatus 200 and the drive assist device 400. According to such a configuration, the drive data-recording apparatus 200 can function as a drive data-recording apparatus 200 in which an installation target vehicle is a data collection vehicle and the drive data is supplied to the drive data analysis device 300, and can also function as a drive assist device 400 in which an installation target vehicle is an assist target vehicle and the drive assist information is received from the drive data analysis device 300. That is, in such a form, the drive assist system 100 is constituted of one drive data analysis device 300 and one or more drive data-recording apparatuses 200, each drive data-recording apparatus 200 supplies drive data relating to the driver of each vehicle to the drive data analysis device 300, and can thereby assist the driver of the vehicle on the basis of the analysis result of the drive data acquired with respect to the vehicle and other vehicles.

The embodiment described above can be represented as a drive data-recording apparatus including a storage device that stores a program and a hardware processor and configured to, by executing the program stored in the storage device by the hardware processor, acquire outside situation information indicating a situation outside a movable body during traveling of the movable body, acquire capability information indicating an outside recognition capability of a driver of the movable body, and process the outside situation information based on the capability information.

Although the embodiment of the present invention has been described, the present invention is not limited to such an embodiment, and various modifications and substitutions can be made without departing from the scope of the present invention.

What is claimed is:

1. A drive data-recording apparatus, comprising:
an outside situation information acquisition part that acquires outside situation information indicating a situation of an outside of a movable body during traveling of the movable body;
a capability information acquisition part that acquires capability information indicating an outside recognition capability of a driver of the movable body; and
an information-processing part that processes the outside situation information based on the capability information.

2. The drive data-recording apparatus according to claim 1,
wherein the outside situation information acquisition part acquires image data in which the outside of the movable body is imaged as the outside situation information,
the capability information acquisition part acquires information indicating eyesight of the driver during driving of the movable body as the capability information, and
the information-processing part processes the image data based on the information indicating the eyesight of the driver.

3. The drive data-recording apparatus according to claim 1,
wherein the outside situation information acquisition part acquires voice data in which a voice of the outside of the movable body is recorded as the outside situation information,
the capability information acquisition part acquires information indicating hearing of the driver during driving of the movable body as the capability information, and
the information-processing part processes the voice data based on the information indicating the hearing of the driver.

4. The drive data-recording apparatus according to claim 1, further comprising:
an information output part that determines an attribute of a device of an output destination and outputs the outside situation information after processing by the information-processing part to the device of the output destination in a case where it is determined that the attribute is a predetermined attribute.

5. The drive data-recording apparatus according to claim 1, further comprising:
a storage part that stores the outside situation information before processing; and
an information output part that commands the information-processing part to process the outside situation information before the processing in a case where it is determined that the outside situation information after processing is output.

6. A drive assist system, comprising:
the data-recording apparatus according to claim 1; and
a drive data analysis device that includes: a drive data collection part that collects drive data which includes at least the capability information and the outside situation information after processing by the information-processing part from one or more drive data-recording apparatuses; a drive data analysis part that analyzes a drive risk relating to driving of the movable body based on the drive data; and an assist information supply part that generates drive assist information for assisting driving of a target person of drive assist based on an analysis result of the drive risk and supplies the generated drive support information to a drive assist device used by the target person.

7. The drive assist system according to claim 6, further comprising
the drive assist device including:
a drive assist information acquisition part that acquires the drive assist information from the drive data analysis device; and
a notification part that notifies the target person of the drive risk relating to driving of the movable body based on the drive assist information.

8. The drive assist system according to claim 7,
wherein the drive data analysis part analyzes the drive risk associated with a location, and
the notification part notifies the target person of an alert relating to the location.

9. A drive data-recording method by way of a computer, the method including:
acquiring outside situation information indicating a situation of an outside of a movable body during traveling of the movable body;
acquiring capability information indicating an outside recognition capability of a driver of the movable body; and
processing the outside situation information based on the capability information.

10. A computer-readable non-transitory recording medium which comprises a program causing a computer to:
acquire outside situation information indicating a situation of an outside of a movable body during traveling of the movable body;
acquire capability information indicating an outside recognition capability of a driver of the movable body; and
process the outside situation information based on the capability information.
